(19) United States
(12) Patent Application Publication
(10) Pub. No.: US 2025/0154800 A1
(43) Pub. Date: May 15, 2025

(54) DOOR LATCH DEVICE

(71) Applicant: MITSUI KINZOKU ACT CORPORATION, Yokohama-shi (JP)

(72) Inventors: Naoya SETO, Kanagawa (JP); Masazumi MIYAGAWA, Kanagawa (JP); Naoki HANAKI, Kanagawa (JP)

(73) Assignee: MITSUI KINZOKU ACT CORPORATION, Yokohama-shi (JP)

(21) Appl. No.: 18/941,353

(22) Filed: Nov. 8, 2024

(30) Foreign Application Priority Data
Nov. 14, 2023 (JP) 2023-193987

(51) Int. Cl. E05B 77/06

(52) U.S. Cl. CPC E05B 77/06

(57) ABSTRACT

A door latch device includes: an open link; and a pawl lever, the open link including: a lever body; an inertial lever portion; and a releasing bias member configured to bias the inertial lever portion at an operating position relative to the lever body, the inertial lever portion being configured to transmit an operation force to the pawl lever only when opening operation of a door handle is performed while the lever body is arranged at an unlock position and the inertial lever portion is arranged at the operating position, wherein the pawl lever is provided with a protruding portion configured to abut on the inertial lever portion to return the inertial lever portion to the operating position when opening operation of the door handle is performed with a preset return stroke while the inertial lever portion is arranged at a non-operating position.

### CROSS-REFERENCE TO RELATED APPLICATION(S)

The present application claims priority to and incorporates by reference the entire contents of Japanese Patent Application No. 2023-193987 filed in Japan on Nov. 14, 2023.

### BACKGROUND

### 1. Field

The present disclosure relates to a door latch device.

### 2. Description of the Related Art

This section provides background information related to door latch devices and is not necessarily prior art to the door latch device of the present disclosure.

As door latch devices of this type, a door latch device including a lever body and an inertial lever portion, for constituting an open link has already been provided. In this door latch device, the inertial lever portion is maintained in a state where the inertial lever portion is arranged at an operating position relative to the lever body by a biasing force of biasing means, for normal use. When the lever body is arranged at an unlock position in this state, performance of opening operation of the door handle causes the inertial lever portion to abut on a pawl lever so that the pawl lever is operated to be released, releasing an engagement state of a pawl with a latch. Meanwhile, when an impact force is applied to a vehicle, the inertial lever portion rotates relative to the lever body against the biasing force of the biasing means, and is arranged at a non-operating position. In this state, even when the lever body is arranged at the unlock position, the inertial lever portion does not abut on the pawl lever, preventing a door from being unexpectedly opened.

In this type of door latch device, a return protruding portion is provided in a housing that accommodates the inertial lever portion. The return protruding portion returns the inertial lever portion to the operating position again, when a predetermined operation, for example, opening operation of the door handle with a preset return stroke is performed after the inertial lever portion is arranged at the non-operating position. This configuration makes it possible to emergently open the door even after the inertial lever portion is arranged at the non-operating position (e.g., see JP 2021-59923 A).

There is a need for a door latch device with which an existing door latch device may be readily replaced.

### SUMMARY

In some embodiments, a door latch device includes: an open link configured to change to an unlocked state and a locked state and operate upon opening operation of a door handle; and a pawl lever configured to release an engagement state of a pawl with a latch when an operation force is applied via the open link, the open link being configured to transmit the operation force to the pawl lever when opening operation of the door handle is performed in the unlocked state, the open link including: a lever body configured to displace to an unlock position corresponding to the unlocked state and a lock position corresponding to the locked state and configured to move according to opening operation of the door handle; an inertial lever portion configured to move to an operating position and a non-operating position relative to the lever body; and a releasing bias member configured to bias the inertial lever portion so that the inertial lever portion is maintained at the operating position relative to the lever body, the inertial lever portion being configured to transmit the operation force to the pawl lever only when opening operation of the door handle is performed while the lever body is arranged at the unlock position and the inertial lever portion is arranged at the operating position, wherein the pawl lever is provided with a protruding portion configured to abut on the inertial lever portion to return the inertial lever portion to the operating position when opening operation of the door handle is performed with a preset return stroke while the inertial lever portion is arranged at the non-operating position.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a view illustrating an appearance of a door latch device according to an embodiment of the present disclosure as viewed from a back side of a vehicle;

FIG. 2 is a view of the door latch device of FIG. 1 with a case partially omitted;

FIG. 3 is a view of an internal structure of the door latch device illustrated in FIG. 1 as viewed from inside the vehicle;

FIGS. 4A and 4B are views of a latch unit of the door latch device illustrated in FIG. 1 as viewed from a front side of the vehicle, where FIG. 4A illustrates a state in which an open link is mounted, and FIG. 4B illustrates a state in which the open link is removed;

FIG. 5 is a view of a main part of the internal structure of the door latch device illustrated in FIG. 1 as viewed from inside the vehicle, the door latch device being in an unlocked state;

FIG. 6 is a view of the main part of the internal structure of the door latch device illustrated in FIG. 1 as viewed from inside the vehicle, the door latch device being in a locked state;

FIGS. 7A and 7B are views of the main part of the internal structure illustrating the inertial lever portion at an operating position in the open link of the door latch device illustrated in FIG. 1, where FIG. 7A is viewed from a back side of the vehicle and FIG. 7B is viewed obliquely forward from below;

FIGS. 8A and 8B are views of the main part of the internal structure illustrating the inertial lever portion at a non-operating position in the open link of the door latch device illustrated in FIG. 1, where FIG. 8A is viewed from a back side of the vehicle and FIG. 8B is viewed obliquely forward from below;

FIG. 9 is an exploded perspective view of the open link of the door latch device illustrated in FIG. 1 as viewed from inside the vehicle;

FIG. 10 is an exploded perspective view of the open link of the door latch device illustrated in FIG. 1 as viewed downward from a back side of the vehicle;

FIGS. 11A and 11B are exploded views of a lever body constituting the open link of the door latch device illustrated in FIG. 1, and the inertial lever portion arranged at an attachment/detachment position relative to the lever body, as viewed from a back side of the vehicle;

FIG. 12 is a perspective view of the inertial lever portion constituting the open link of the door latch device illustrated in FIG. 1;

FIGS. 13A to 13C are views of the inertial lever portion being at the operating position in the open link of the door latch device illustrated in FIG. 1, where FIG. 13A is viewed from inside the vehicle, FIG. 13B is viewed from a back side of the vehicle, and FIG. 13C is viewed from above the vehicle;

FIGS. 14A to 14C are partial views of the inertial lever portion being at a first non-operating position in the open link of the door latch device illustrated in FIG. 1, where FIG. 14A is viewed from inside the vehicle, FIG. 14B is viewed from a back side of the vehicle, and FIG. 14C is viewed from above the vehicle;

FIGS. 15A to 15C are partial views of the inertial lever portion being at a second non-operating position in the open link of the door latch device illustrated in FIG. 1, where FIG. 15A is viewed from inside the vehicle, FIG. 15B is viewed from a back side of the vehicle, and FIG. 15C is viewed from above the vehicle;

FIGS. 16A to 16C are views of a relative position between the open link of the door latch device illustrated in FIG. 1 and a protruding portion provided at a pawl lever, where FIG. 16A is a view of the inertial lever portion being at the second non-operating position as viewed from a back side of the vehicle, FIG. 16B is a view of the inertial lever portion being at the second non-operating position as viewed from outside the vehicle, and FIG. 16C is a perspective view of the inertial lever portion being at the second non-operating position as viewed from outside a front side of the vehicle; and

FIG. 17 is a perspective view illustrating how the inertial lever portion being at the second non-operating position abuts on the protruding portion of the pawl lever, in the open link of the door latch device illustrated in FIG. 1.

### DETAILED DESCRIPTION

Preferred embodiments of a door latch device according to the present disclosure will be described in detail below with reference to the accompanying drawings. Note that in the following description, for the sake of convenience, directions are indicated in a state in which the door latch device is mounted on a vehicle.

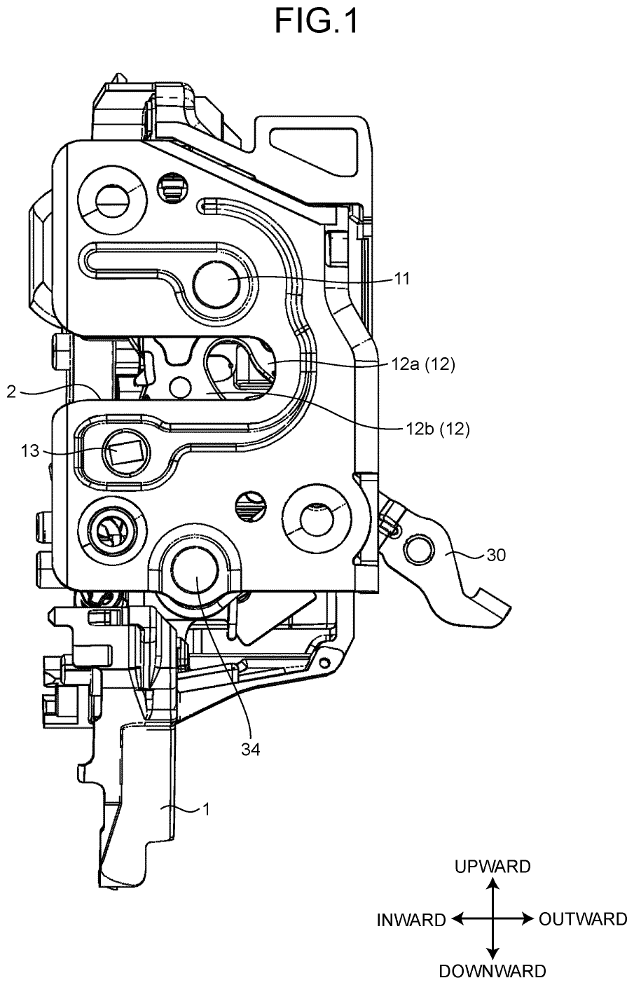

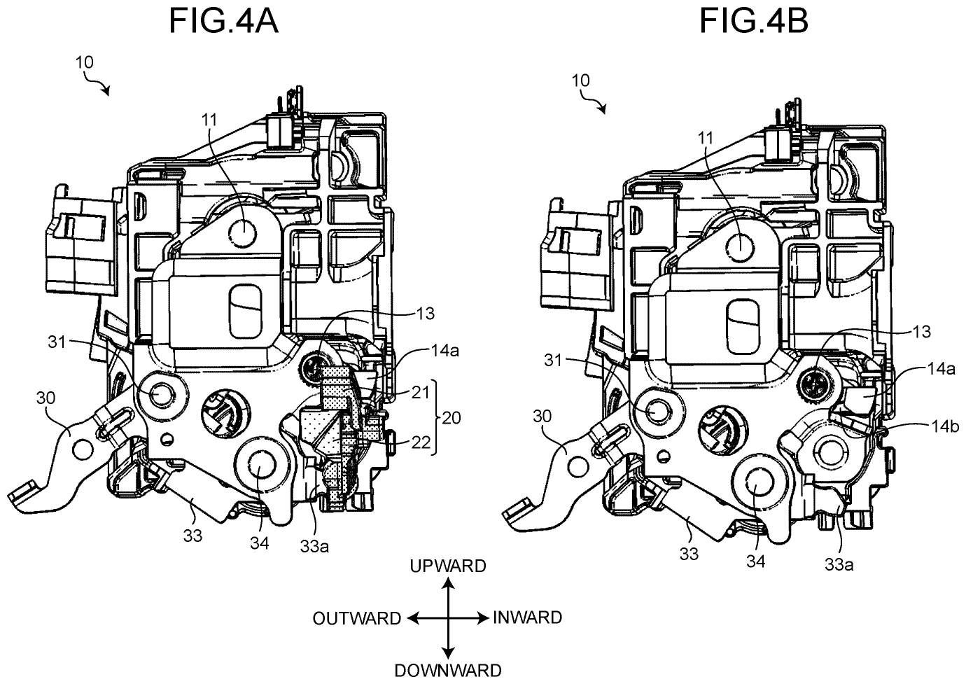

FIGS. 1 to 4B each illustrate a door latch device according to an embodiment of the present disclosure. Although not illustrated, the door latch device exemplified here is mounted on a front hinged side door arranged on the right side of a four-wheeled vehicle, and performs opening/closing control of the side door by changing an engagement state with a striker (not illustrated) provided at the vehicle according to opening operation of a door handle or a locking/unlocking operation by a remote control key or lock knob. In the door latch device, a latch unit 10 is provided inside a case 1.

The latch unit 10 includes a latch 12 that is arranged rotatably via a latch shaft 11 and a pawl 14 that is arranged rotatably via a pawl shaft 13. The latch shaft 11 and the pawl shaft 13 each extend substantially horizontally in a longitudinal direction of the vehicle. In the present embodiment, the latch shaft 11 is provided at a portion of the vehicle positioned above a striker entrance groove 2 of the case 1, and the pawl shaft 13 is provided at a portion on the inner side of the vehicle relative to the latch shaft 11 in a portion of the vehicle positioned below the striker entrance groove 2. The striker enters the striker entrance groove 2 relatively from the left side of FIG. 1, which is the inside of the vehicle, when the side door is closed to the vehicle.

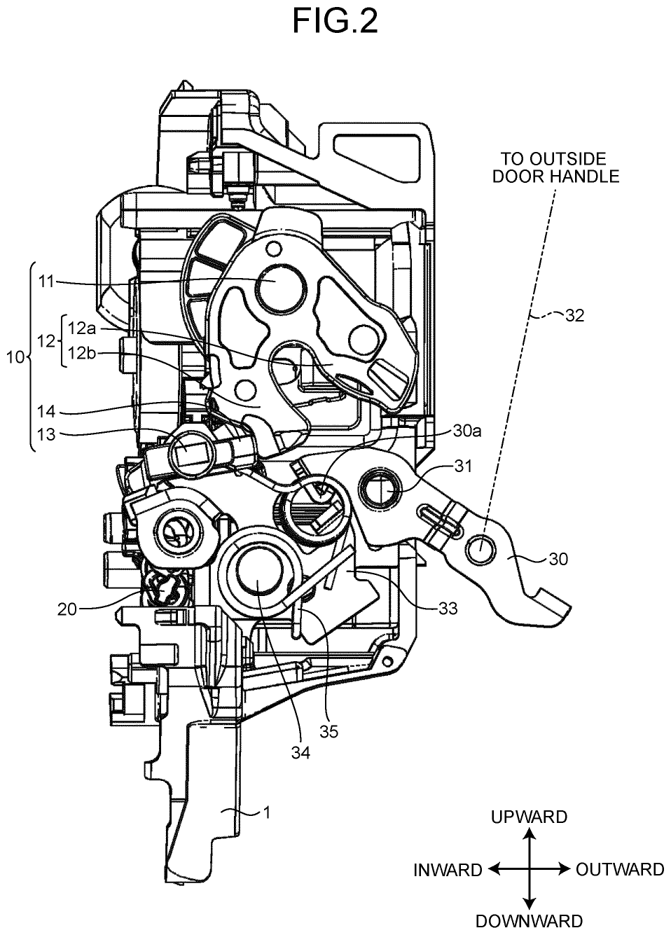

The latch 12 includes a striker abutment portion 12a and a hook portion 12b, and the latch 12 is biased in a release direction (clockwise in FIG. 2) by a spring force of a latch spring which is not illustrated, and arranged at a meshing standby position. The meshing standby position represents a state in which the hook portion 12b is retracted to the upper side of the striker entrance groove 2 while the striker abutment portion 12a is arranged on the back side (right side in FIG. 2) of the striker entrance groove 2. When the side door is closed and the striker enters the striker entrance groove 2, the striker abuts on the striker abutment portion 12a, and therefore, the latch 12 rotates counterclockwise in FIG. 2 against the spring force of the latch spring, and the hook portion 12b is arranged across an opening side portion of the striker entrance groove 2.

When the hook portion 12b of the latch 12 is arranged across the striker entrance groove 2, the pawl 14 engages with the hook portion 12b, and the latch 12 is prevented from rotating in the release direction. The pawl 14 is biased in a direction (counterclockwise in FIG. 2) to engage with the latch 12 by a spring force of a pawl spring which is not illustrated. Therefore, when the striker enters the striker entrance groove 2 and the hook portion 12b of the latch 12 is arranged across the striker entrance groove 2, the spring force of the pawl spring engages the pawl 14 with the hook portion 12b, and this state is maintained.

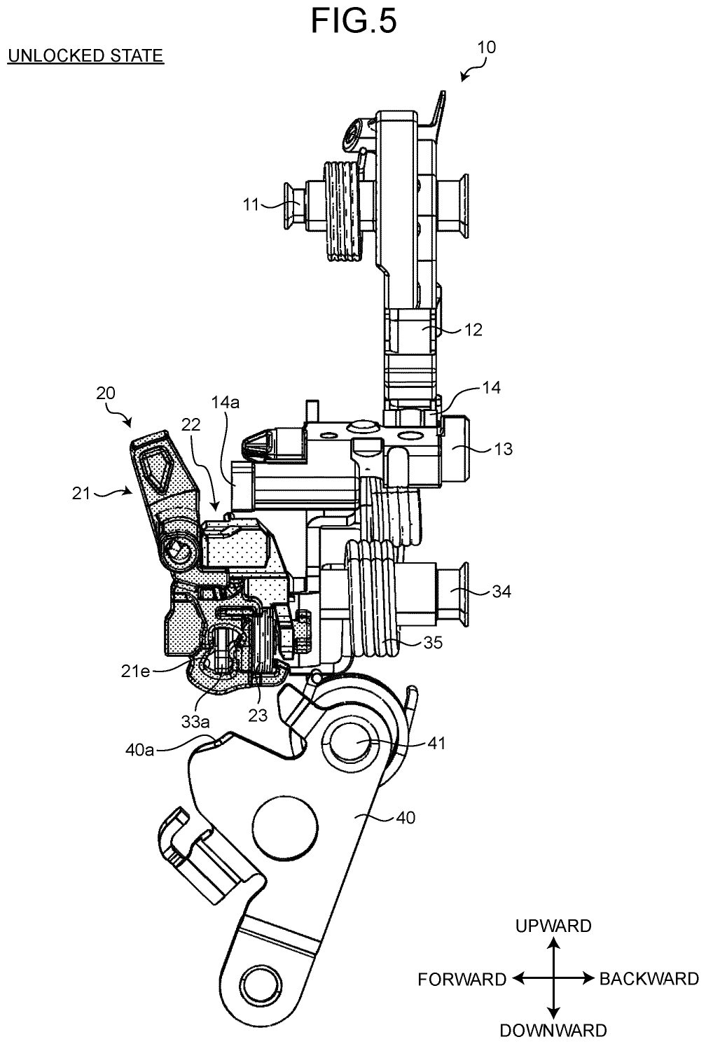

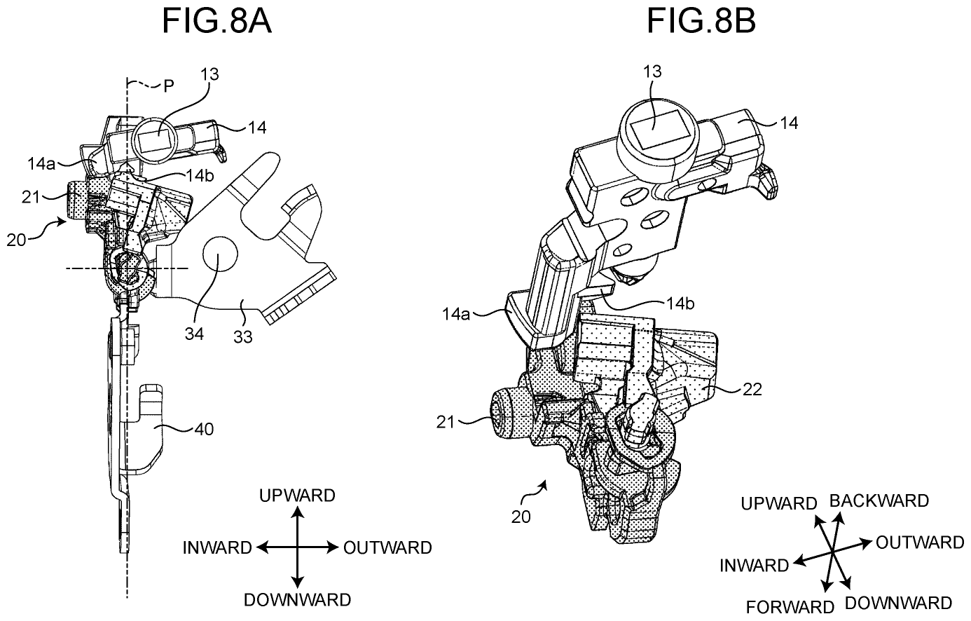

As illustrated in FIGS. 5 to 8B, the pawl 14 is integrally provided with a pawl lever 14a. The pawl lever 14a extends toward the inside of the vehicle, from a portion positioned on the front side of the vehicle relative to the pawl 14 in the pawl shaft 13, and then, the pawl lever 14a is bent toward the front side of the vehicle. When the pawl lever 14a is moved upward against the spring force of the pawl spring, the pawl 14 rotates clockwise in FIG. 2, and therefore, an engagement state between the pawl 14 and the latch 12 is allowed to be released.

As illustrated in FIGS. 2 to 8B, an open link 20 is arranged at a portion below the pawl lever 14a, in the case 1. The open link 20 is provided in the case 1 so as to be movably arranged vertically by the operations of an outside handle lever 30 and an inside handle lever 40, rotated about an axis extending in a horizontal direction (inward/outward) of the vehicle by the operations of a lock unit 50, and arranged at an unlock position and a lock position which are described later.

As illustrated in FIG. 2, the outside handle lever 30 is arranged so as to be rotated by an outside lever shaft 31 extending in a longitudinal direction of the vehicle. The outside lever shaft 31 is provided at a portion positioned near the outside of the vehicle relative to the pawl shaft 13. Although not illustrated, the outside handle lever 30 has an end that is positioned near the outside of the vehicle and with which an outside door handle (door handle) of the side door is cooperated via an outside cable 32. The outside handle lever 30 has an end 30a that is positioned near the inside of the vehicle, and an open lever 33 is arranged so as to be in cooperation with the end 30a. The open lever 33 is arranged so as to be rotated by an open lever shaft 34 extending in a longitudinal direction of the vehicle. The open lever shaft 34 is provided at a portion on the inner side and lower side of the vehicle, relative to the outside lever shaft 31. The open lever 33 has an engagement end 33a positioned on the inner side of the vehicle, and the engagement end 33a is engaged with a rotation center portion (engagement hole 21e to be described later) of the open link 20.

When opening operation of the outside door handle is performed, the outside handle lever 30 rotates counterclockwise in FIG. 2 via the outside cable 32, and the open lever 33 rotates clockwise in FIG. 2 with the rotation of the outside handle lever 30. When the open lever 33 rotates clockwise, the open link 20 moves upward via the engagement end 33a. When the opening operation of the outside door handle is stopped in this state, the open lever 33 rotates counterclockwise by a spring force of a return spring 35, and each of the open link 20 and the outside handle lever 30 returns to the original state.

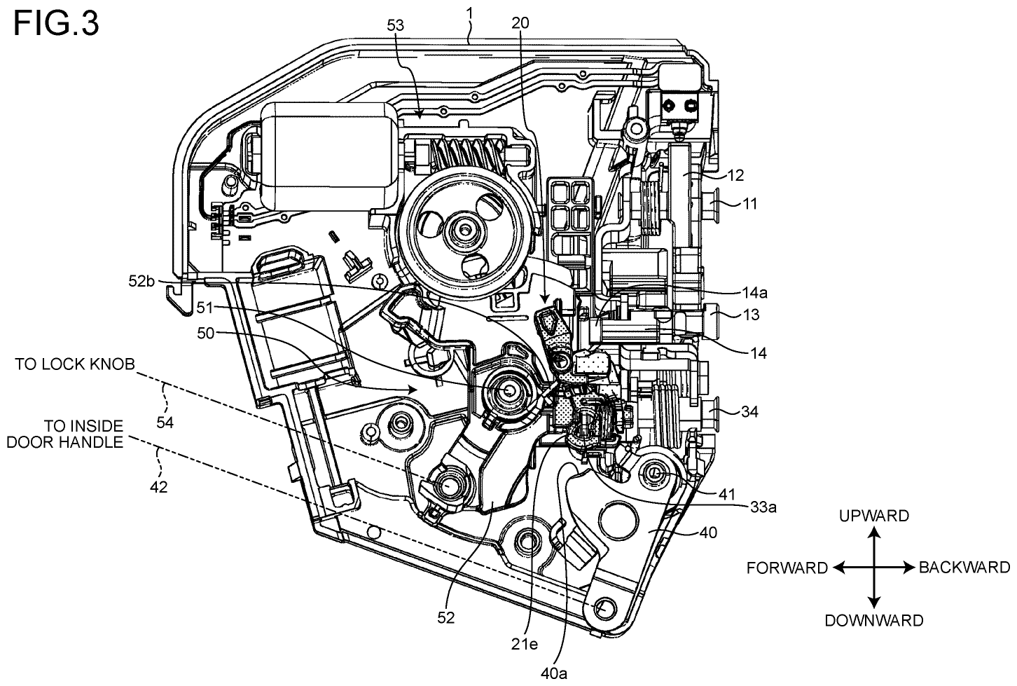

As illustrated in FIG. 3, the inside handle lever 40 is arranged at a portion below the open link 20, so as to be rotated by an inside lever shaft 41 extending in a horizontal direction (inward/outward) of the vehicle, and a front end portion 40a positioned on the front side thereof faces a lower end surface of the open link 20. Although not illustrated, the inside handle lever 40 has an end that is positioned below the inside lever shaft 41 with which an inside door handle (door handle) of the side door is cooperated via an inside cable 42.

When opening operation of the inside door handle is performed, the inside handle lever 40 rotates clockwise in FIG. 3 via the inside cable 42, and the open link 20 moves upward via the front end portion 40a of the inside handle lever 40. At this time, the open lever 33 rotates clockwise in FIG. 2 with the upward movement of the open link 20. When the opening operation of the inside door handle is stopped, the open lever 33 rotates counterclockwise by the spring force of the return spring 35, and each of the open link 20 and the inside handle lever 40 returns to the original state.

As illustrated in FIG. 3, the lock unit 50 includes a lock lever 52 that rotates about an axis of a lock shaft 51 extending in a horizontal direction (inward/outward) of the vehicle, and the lock unit 50 engages with the open link 20 via an engagement piece 52a of a lock lever 52. The lock unit 50 includes an actuator unit 53 and a lock cable 54 that are cooperated with the lock lever 52. The actuator unit 53 is operated according to a lock operation and an unlock operation of the remote control key owned by a user of the vehicle to rotate the lock lever 52. The lock cable 54 transmits a lock operation and an unlock operation of the lock knob, which is not illustrated, provided at the side door, to the lock lever 52 to rotate the lock lever 52.

In this lock unit 50, upon performance of the unlock operation of the remote control key or the lock knob, the lock lever 52 rotates clockwise in FIG. 3 via the actuator unit 53 or the lock cable 54. On the other hand, upon performance of the lock operation of the remote control key or the lock knob, the lock lever 52 rotates counterclockwise in FIG. 3 via the actuator unit 53 or the lock cable 54, in the lock unit 50.

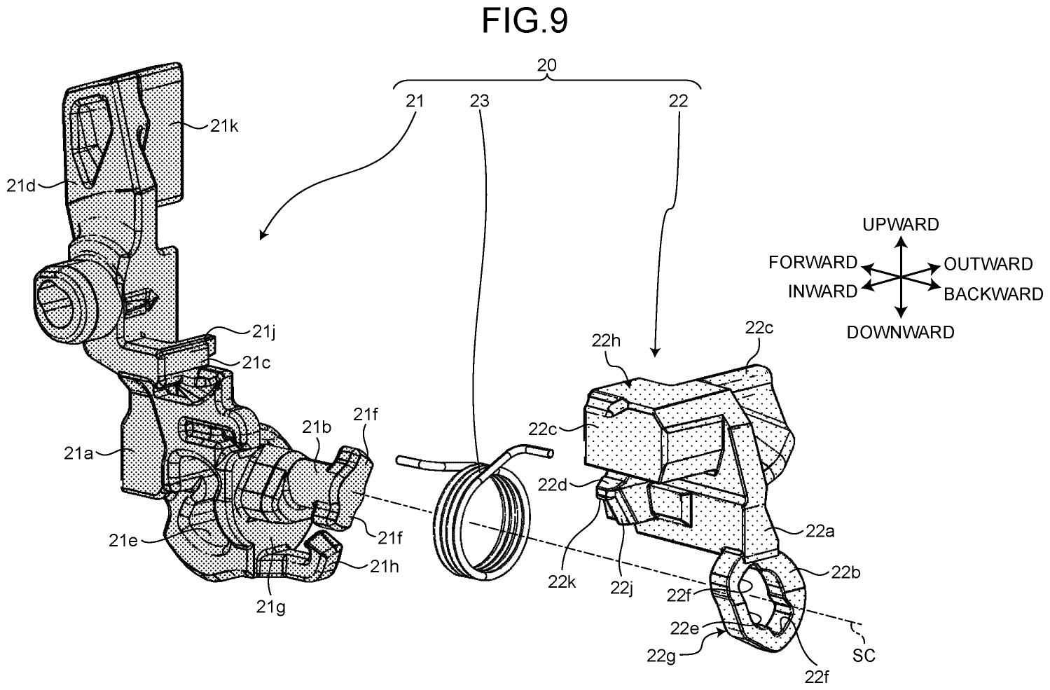

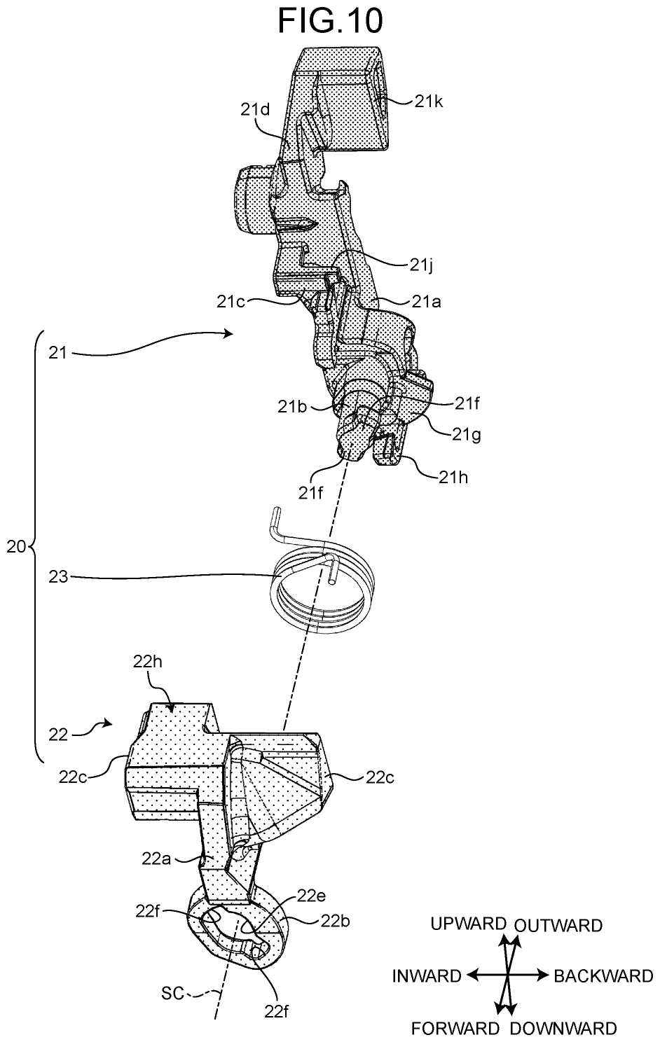

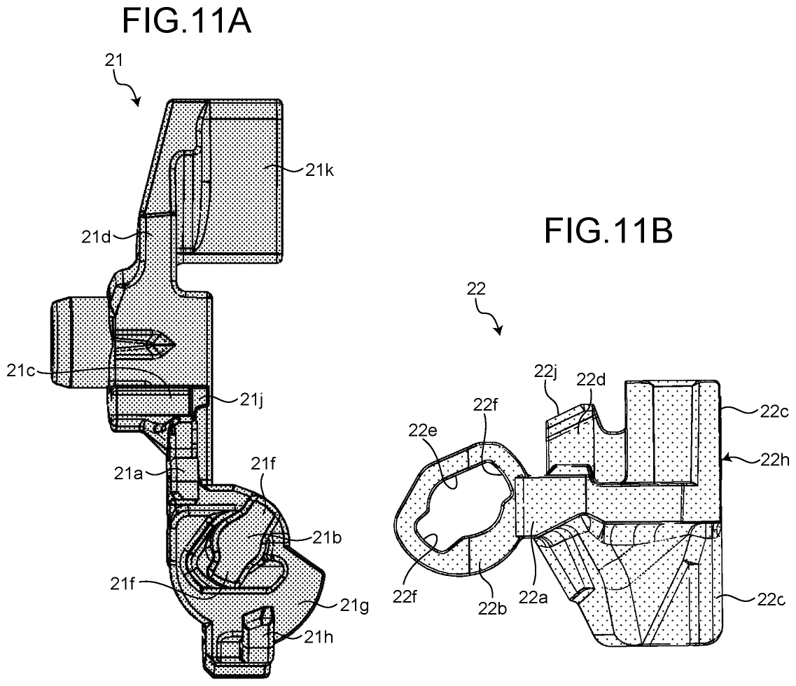

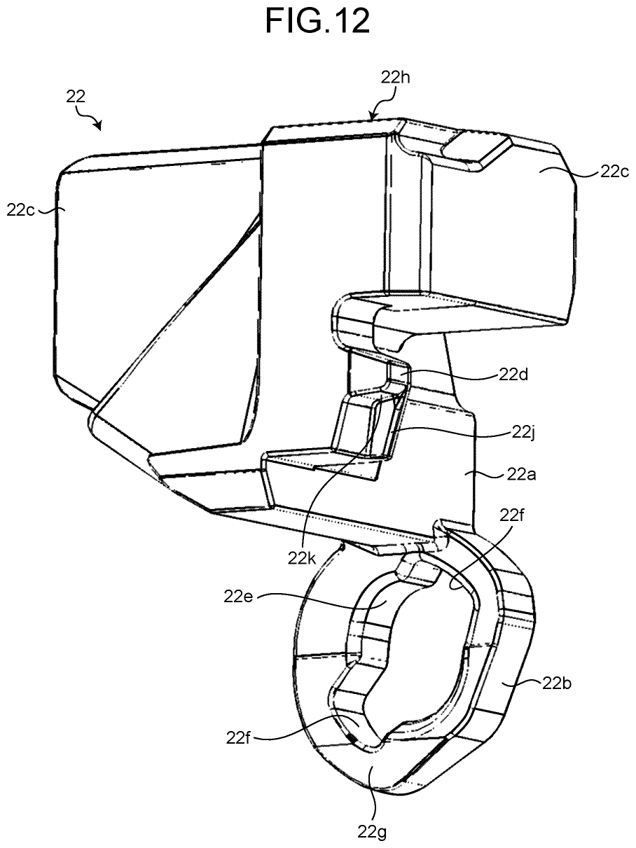

In the present embodiment, as illustrated in FIGS. 9 to 15C, the open link 20 described above includes a lever body 21, an inertial lever portion 22, and a torsion spring (releasing bias member and shifting bias member) 23. Note that in the drawings illustrating the open link 20, the lever body 21 and the inertial lever portion 22 are differently dotted for clarity of shape.

The lever body 21 includes a main body base portion 21a and a support shaft portion 21b that are positioned at a lower end, and an abutment protrusion (rotation blocking portion and shift blocking portion) 21c and an engagement protrusion 21d that protrude upward from the main body base portion 21a. The main body base portion 21a is provided with the engagement hole 21e through which the engagement end 33a of the above-described open lever 33 positioned near the inside of the vehicle is engageably inserted. The engagement hole 21e is a deformed hole that penetrates the main body base portion 21a in a horizontal direction (inward/outward) of the vehicle, and is engaged with the engagement end 33a so as to be rotatable and so as not to relatively moved in a vertical direction. The support shaft portion 21b has a columnar shape protruding from a portion of the main body base portion 21a positioned near the back side of the vehicle toward the back side of the vehicle. Two protruding engagement portions 21f (engagement mechanism) are provided at a protruding end of the support shaft portion 21b. The two protruding engagement portions 21f protrude radially from positions shifted from each other by 180° in the circumferential direction of the support shaft portion 21b. In the present embodiment, when the abutment protrusion 21c and the engagement protrusion 21d extend upward from the main body base portion 21a, one of the protruding engagement portions 21f extends upward and outward from the support shaft portion 21b, and the other of the protruding engagement portions 21f extends downward and inward from the support shaft portion 21b. A seating surface 21g facing the back side of the vehicle is provided at a portion of the main body base portion 21a surrounding the support shaft portion 21b, and an engagement claw 21h is provided at a portion below the seating surface 21g. The seating surface 21g is a surface provided so as to be substantially orthogonal to an axis (shifting axis) SC of the support shaft portion 21b. The engagement claw 21h temporarily holds the torsion spring 23 with the seating surface 21g. In the present embodiment, the engagement claw 21h is provided so as to extend backward along the support shaft portion 21b from the seating surface 21g and then bend upward. As is clear from the drawings, the seating surface 21g is provided to protrude to both sides of the engagement claw 21h, in a range exceeding approximately 180° so as to have a contact area with the torsion spring 23 larger than that of the engagement claw 21h. In the illustrated examples, when viewed from the back side of the vehicle, the seating surface 21g is continuously provided in a range corresponding to 3 o'clock to 12 o'clock position around the axis SC of the support shaft portion 21b.

The abutment protrusion 21c protrudes upward from a portion positioned above the engagement hole 21e in the main body base portion 21a. The abutment protrusion 21c is provided with a restriction protrusion (shift blocking portion) 21j. The restriction protrusion 21j protrudes from an upper end of the abutment protrusion 21c toward the outside of the vehicle. The engagement protrusion 21d protrudes upward from a portion of the main body base portion 21a positioned near the front side of the vehicle, and has a lock engagement portion 21k at an upper end. The lock engagement portion 21k is a protrusion protruding outward. This lock engagement portion 21k is maintained to be always engaged with the engagement piece 52a of the lock lever 52 described above by a spring force of a lock engagement spring 52b (see FIG. 3).

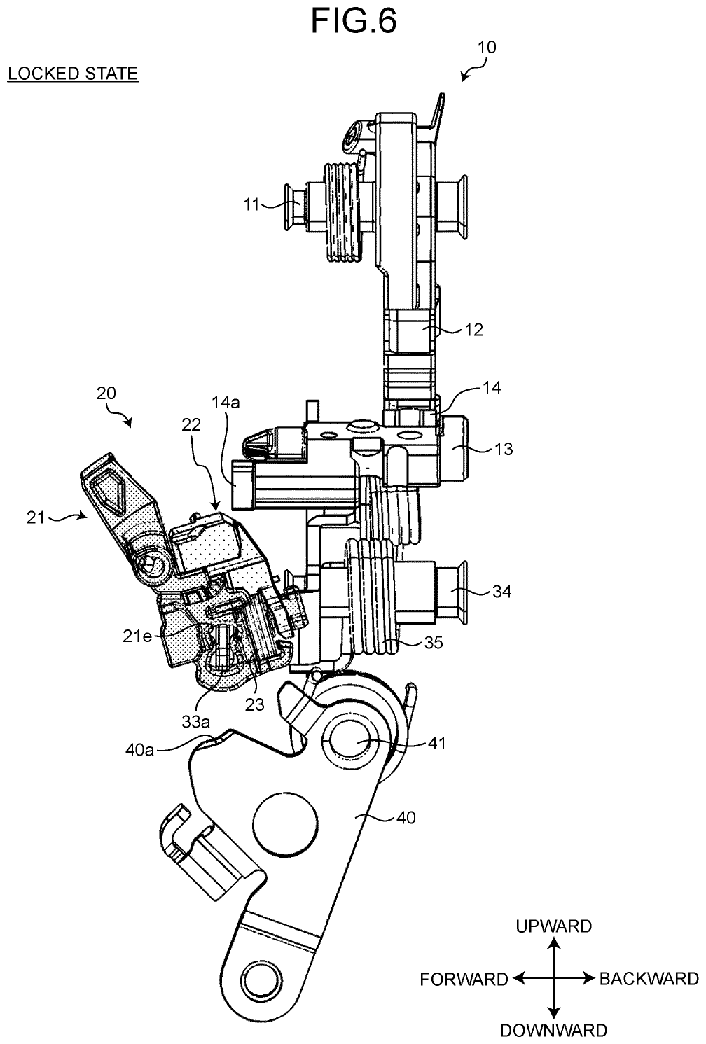

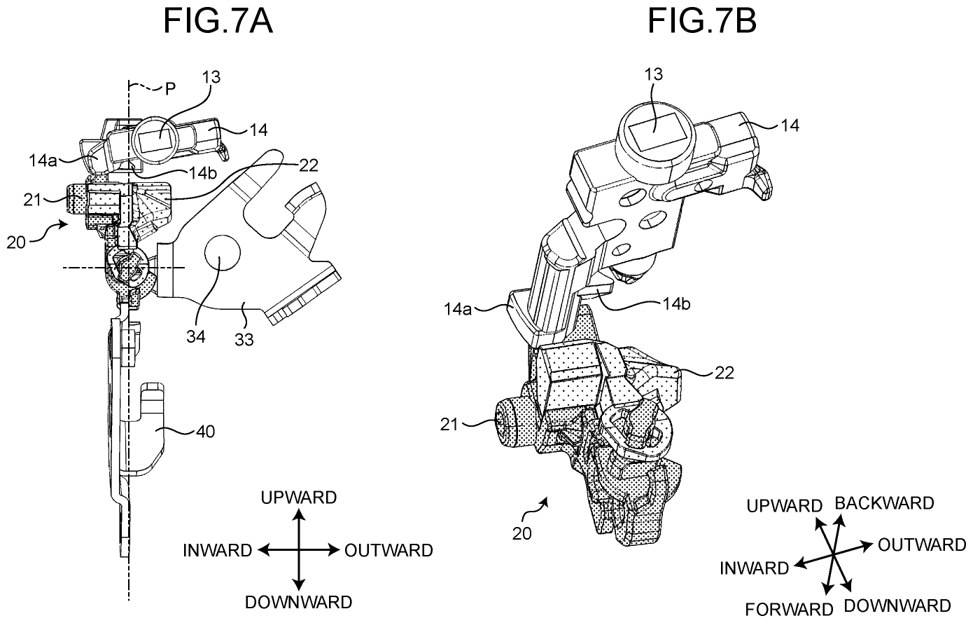

When the opening operation of the outside door handle or the inside door handle is performed, the lever body 21 described above moves upward along a virtual operation plane P including the axis SC of the support shaft portion 21b and extending vertically along with the upward movement of the engagement end 33a of the open lever 33 (see FIGS. 7A and 7B). When the lock lever 52 rotates counterclockwise in FIG. 3 with the lock operation of the remote control key or lock knob, the lever body 21 rotates about the engagement hole 21e through the engagement piece 52a and the lock engagement portion 21k and is arranged at a lock position inclined forward (locked state) as illustrated in FIG. 6. On the other hand, when the lock lever 52 rotates clockwise in FIG. 3 with the unlock operation of the remote control key or lock knob, the lever body 21 rotates reversely about the engagement hole 21e by the spring force of the lock engagement spring 52b, and is arranged at a substantially upright unlock position (unlocked state) as illustrated in FIG. 5. The lock position and the unlock position of the lever body 21 correspond to the locked state and the unlocked state of the open link 20, respectively. In other words, the open link 20 is brought into the locked state when the lever body 21 is arranged at the lock position, and the open link 20 is brought into the unlocked state when the lever body 21 is arranged at the unlock position.

The inertial lever portion 22 includes an insertion portion 22b in a portion on a lower back side of a lever base portion 22a, and an inertial mass portion 22c and a projection (rotation blocking portion and shift blocking portion) 22d at a portion on an inner side of the lever base portion 22a. The lever base portion 22a has a thick plate shape extending vertically in a longitudinal direction. The insertion portion 22b protrudes from the lever base portion 22a in a direction substantially orthogonal to the longitudinal direction. The insertion portion 22b is provided with an insertion hole 22e, two insertion cutout portions (engagement mechanism) 22f, and a spring receiving surface (biasing force receiving surface) 22g. The insertion hole 22e is provided with a circular through-hole through which the support shaft portion 21b of the lever body 21 is rotatably inserted. The two insertion cutout portions 22f are cutouts formed radially from the insertion hole 22e, and are provided at positions shifted from each other by approximately 180° in the circumferential direction. When the support shaft portion 21b is inserted through the insertion hole 22e, the two protruding engagement portions 21f are configured to be inserted through these insertion cutout portions 22f. In the present embodiment, when the lever base portion 22a is arranged vertically, one of the insertion cutout portions 22f extends upward and inward from the insertion hole 22e, and the other of the insertion cutout portions 22f extends downward and outward from the insertion hole 22e. The spring receiving surface 22g is provided on a lower side portion of a surface facing the seating surface 21g, and is gradually inclined backward toward the lower side.

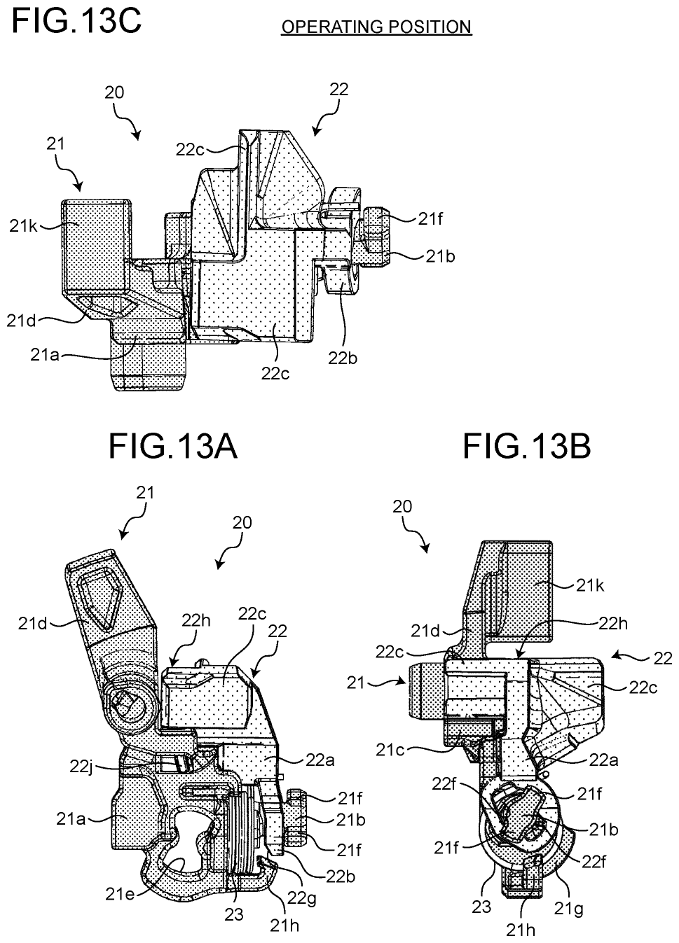

The inertial mass portion 22c is provided to have a configuration in which an upper end of the inertial lever portion 22 has a larger mass than a lower end, and protrudes inward and outward from the upper end of the lever base portion 22a. A substantially flat press abutment surface 22h is constituted at an upper end of a portion of the inertial mass portion 22c on the inner side relative to the lever base portion 22a. The projection 22d protrudes inward from a portion on the front side of the vehicle relative to the inertial mass portion 22c. The projection 22d is provided with an inclined protrusion 22j and an inclined surface 22k at a portion on the inner side. The inclined protrusion 22j is a protruding portion inclined upward so as to be positioned gradually inward. The inclined surface 22k is provided at a portion forward from and above the inclined protrusion 22j, and is inclined upward so as to be positioned gradually inward. The inclined surface 22k has an inclination angle that is formed to be steeper than the inclination angle of the inclined protrusion 22j. As illustrated in FIGS. 13A to 15C, the inertial lever portion 22 is arranged at the lever body 21 by inserting the support shaft portion 21b through the insertion hole 22e so that the insertion portion 22b faces the seating surface 21g. The inertial lever portion 22 arranged at the lever body 21 is rotatable about the axis SC of the support shaft portion 21b relative to the lever body 21, is movable along the axis SC of the support shaft portion 21b, and is configured to be arranged to be inclined so that the upper end is positioned backward around the lower end.

In other words, as illustrated in FIGS. 13A to 13C, the inertial lever portion 22 is located at the operating position, when the inertial mass portion 22c is arranged substantially vertically upward in a state where the axis of the insertion hole 22e is substantially parallel to the axis SC of the support shaft portion 21b and is positioned on the foremost side relative to the lever body 21. At this operating position, the inertial mass portion 22c closely faces a portion of the abutment protrusion 21c positioned near the outside of the vehicle. At this time, the projection 22d of the inertial lever portion 22 is arranged between the abutment protrusion 21c and the engagement protrusion 21d, forward from the restriction protrusion 21j of the lever body 21, and the abutment protrusion 21c and the projection 22d face each other in the direction of the axis SC of the support shaft portion 21b. In addition, the insertion cutout portions 22f formed in the inertial lever portion 22 are inclined relative to the virtual operation plane P described above. Therefore, each of the insertion cutout portions 22f are allowed to have a reduced size in a horizontal direction (inward/outward) of the insertion portion 22b, as compared with the insertion cutout portions 22f that are provided in a horizontal direction, advantageously in housing space.

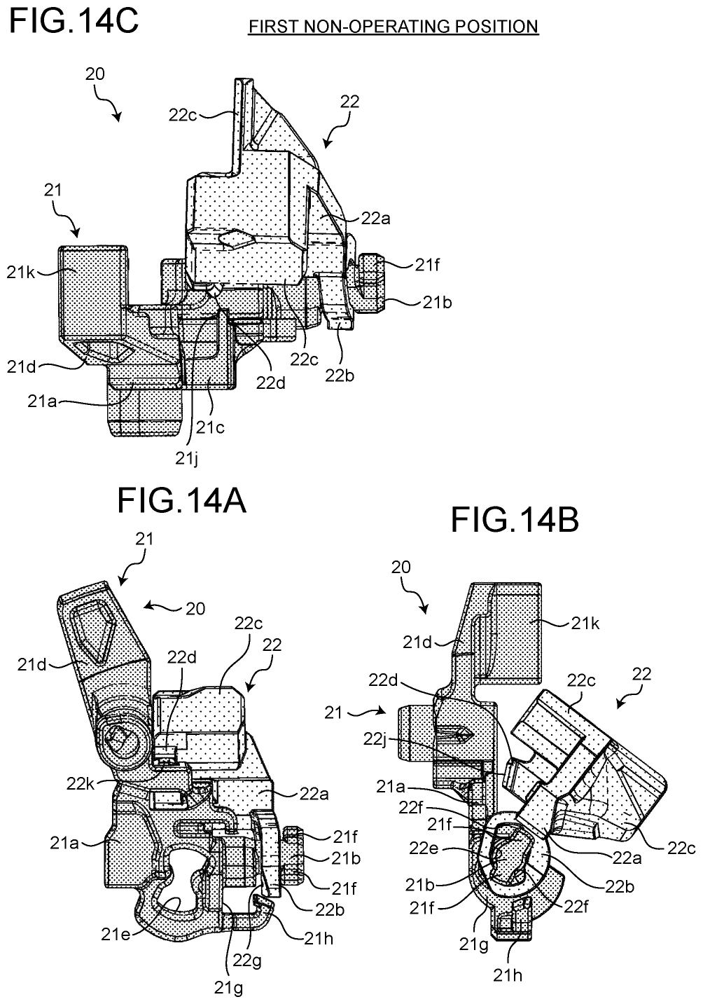

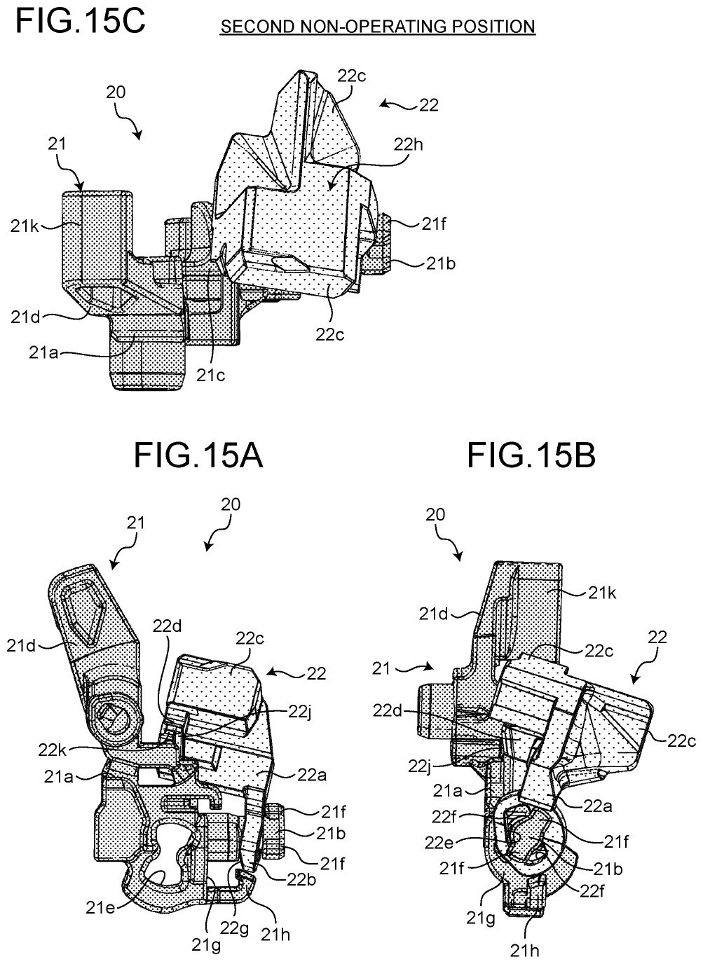

Meanwhile, when the inertial lever portion 22 rotates clockwise relative to the lever body 21 as viewed from the back side of the vehicle, as illustrated in FIGS. 14A to 14C, the inclined protrusion 22j of the projection 22d is separated from between the abutment protrusion 21c and the engagement protrusion 21d of the lever body 21, further moving to a position beyond the restriction protrusion 21j (first non-operating position). Rotation of the inclined protrusion 22j of the projection 22d to a position beyond the restriction protrusion 21j allows the inertial lever portion 22 to move to the back side of the vehicle in the direction of the axis SC of the support shaft portion 21b relative to the lever body 21. In other words, as illustrated in FIGS. 15A to 15C, the inertial lever portion 22 moves backward in the direction of the axis SC of the support shaft portion 21b, and the inertial mass portion 22c at the upper end is inclined backward (second non-operating position). At this time, the abutment protrusion 21c and the projection 22d are arranged so as to face each other in the circumferential direction about the support shaft portion 21b.

The torsion spring 23 is interposed between the seating surface 21g provided at the main body base portion 21a of the lever body 21 and the insertion portion 22b of the inertial lever portion 22 so as to be wound around the support shaft portion 21b, and has one end cooperated with the lever body 21 and the other end cooperated with the inertial lever portion 22. When viewed from the back side, the torsion spring 23 rotationally biases the inertial lever portion 22 counterclockwise about the axis SC of the support shaft portion 21b, relative to the lever body 21, and biases the insertion portion 22b of the inertial lever portion 22 backward in the direction of the axis SC of the support shaft portion 21b, relative to the lever body 21.

As illustrated in FIGS. 9 to 11B, in order to mount the inertial lever portion 22 to the lever body 21, the torsion spring 23 is held to be temporarily held by the support shaft portion 21b first. In other words, the torsion spring 23 is arranged between the seating surface 21g and the engagement claw 21h of the lever body 21. In this state, when the inertial lever portion 22 is rotated about the axis SC of the support shaft portion 21b after the insertion portion 22b of the inertial lever portion 22 is mounted on the support shaft portion 21b through the insertion hole 22e, the torsion spring 23 is allowed to be mounted between the seating surface 21g of the lever body 21 and the spring receiving surface 22g of the inertial lever portion 22. Here, the lever body 21 is provided with the seating surface 21g in a range exceeding 180°. Therefore, it is possible to temporarily hold the torsion spring 23 in a stable posture. Thereafter, when one end of the torsion spring 23 is cooperated with the lever body 21 and the other end is cooperated with the inertial lever portion 22, the inertial lever portion 22 is biased counterclockwise relative to the lever body 21 when viewed from the back side. Therefore, when the inertial lever portion 22 is arranged on the foremost side relative to the lever body 21 against the spring force along the axis of the torsion spring 23, the inertial lever portion 22 is arranged at the operating position by the spring force of the torsion spring 23 in the rotation direction. Here, the torsion spring 23 is in a deflected state, that is, in a spring force storage state, between the seating surface 21g of the lever body 21 and the insertion portion 22b of the inertial lever portion 22.

As described above, when the inertial lever portion 22 is arranged at the operating position, the inclined protrusion 22j of the projection 22d is arranged between the abutment protrusion 21c and the engagement protrusion 21d, forward from the restriction protrusion 21j of the lever body 21, and the abutment protrusion 21c and the projection 22d face each other in the direction of the axis SC of the support shaft portion 21b, and therefore, the inertial lever portion 22 is maintained at the operating position against the spring force along the axis of the torsion spring 23. The insertion cutout portions 22f formed in the inertial lever portion 22 are arranged in an attitude inclined relative to the virtual operation plane P described above. Therefore, each of the insertion cutout portions 22f are allowed to have a reduced size in a horizontal direction (inward/outward) of the insertion portion 22b, as compared with the insertion cutout portions 22f orthogonal to the operation plane P, advantageously in housing space.

As illustrated in FIGS. 1 to 8B, the open link 20 configured as described above is mounted to the latch unit 10 in a state where the support shaft portion 21b of the lever body 21 extends in the longitudinal direction of the vehicle and the inertial lever portion 22 is arranged at the operating position. The latch unit 10 to which the open link 20 is attached is arranged in the case 1 and mounted on the vehicle.

In normal use, the inertial lever portion 22 is maintained at the operating position by the spring force of the torsion spring 23 in the rotation direction. Therefore, as illustrated in FIG. 5, when the lever body 21 is arranged at the unlock position, that is, when the open link 20 is in the unlocked state, the press abutment surface 22h of the inertial lever portion 22 faces a lower surface of the pawl lever 14a. Therefore, when the lever body 21 moves upward by the opening operation of the outside door handle or opening operation of the inside door handle, the pawl lever 14a moves upward by abutment of the press abutment surface 22h, the engagement state of the pawl 14 with the latch 12 is released, and the side door is allowed to be opened.

Meanwhile, upon lock operation of the remote control key or lock knob from the operating position described above, the lock lever 52 rotates counterclockwise in FIG. 3, the lever body 21 and the inertial lever portion 22 are integrally inclined forward, and the open link 20 is brought into the locked state. In this locked state, as illustrated in FIG. 6, the press abutment surface 22h of the inertial lever portion 22 is arranged forward from the pawl lever 14a, and therefore, even when the lever body 21 moves upward by the opening operation of the outside door handle or opening operation of the inside door handle, the inertial lever portion 22 does not abut on the pawl lever 14a, and the engagement state of the pawl 14 with the latch 12 is maintained. Accordingly, when the door latch device is in the locked state, the side door cannot be opened remaining closed to the vehicle, even when the outside door handle or the inside door handle is operated.

When an impact force is mainly applied in the horizontal direction (inward/outward) to the above vehicle including the door latch device due to a collision from a lateral side or the like, the inertial lever portion 22 having the upper end as the inertial mass portion 22c rotates relative to the lever body 21 against the spring force of the torsion spring 23 in the rotation direction, reaching the first non-operating position. When the inertial lever portion 22 reaches the first non-operating position, the inertial lever portion 22 moves to the second non-operating position relative to the lever body 21 by the spring force along the axis of the torsion spring 23. Therefore, the abutment protrusion 21c and the projection 22d overlap each other in the circumferential direction, and the inertial lever portion 22 is prevented from returning to the operating position through the first non-operating position by the spring force of the torsion spring 23 in the rotation direction. Therefore, in this state, as illustrated in FIGS. 15A to 15C, even when the open link 20 is in the unlocked state and the lever body 21 is moved upward by the opening operation of the outside door handle or opening operation of the inside door handle, the press abutment surface 22h does not abut on the pawl lever 14a, and the engagement state of the pawl 14 with the latch 12 is maintained. Accordingly, it is possible to prevent the side door from being unexpectedly opened immediately after the impact force is applied to the vehicle.

Moreover, in the above state, the inertial lever portion 22 rotates counterclockwise when viewed from the back side of the vehicle by the spring force of the torsion spring 23 in the rotation direction, and a front end surface of the inclined protrusion 22j is kept facing the restriction protrusion 21j, preventing forward movement of the inertial lever portion 22 to the lever body 21. In other words, after the inertial lever portion 22 is arranged at the second non-operating position relative to the lever body 21, even if the outside door handle or the inside door handle moves in the same direction as that of the opening operation due to the influence of the impact force or the like applied thereafter to the vehicle, the inertial lever portion 22 does not move to the first non-operating position or not return to the operating position. Therefore, it is possible to more reliably prevent the side door from being unexpectedly opened.

Here, as described above, even after the inertial lever portion 22 is once arranged at the second non-operating position, there may be a situation where opening of the side door is urgently required. Therefore, in the door latch device described above, a mechanism for returning the inertial lever portion 22 arranged at the second non-operating position to the operating position is added. In other words, in the door latch device described above, a protruding portion 14b is integrally provided at the pawl lever 14a constituting the latch unit 10. The protruding portion 14b is provided at a portion of the pawl lever 14a above the inertial lever portion 22 arranged at the second non-operating position, and is configured to return the inertial lever portion 22 to the operating position when the opening operation of the outside door handle or the opening operation of the inside door handle is performed with a stroke larger than usual in a state where the inertial lever portion 22 is arranged at the second non-operating position.

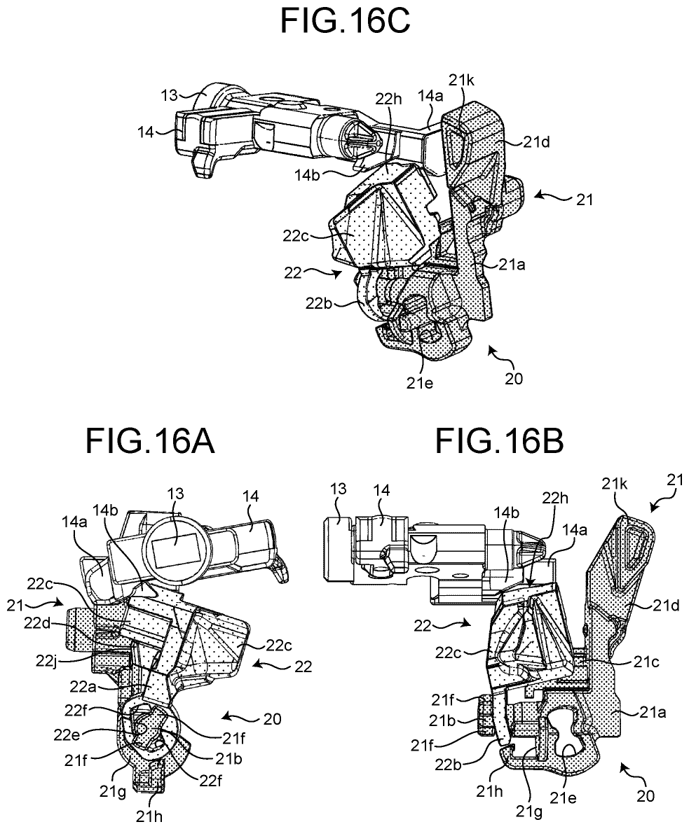

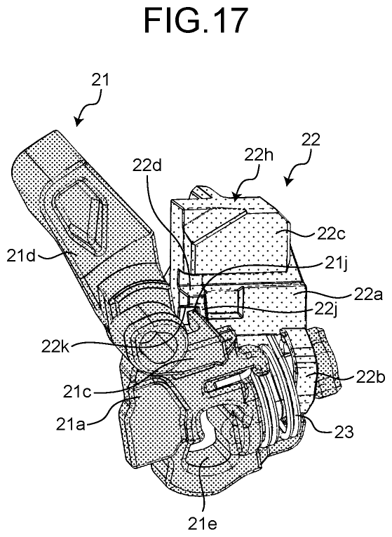

More specifically, as illustrated in FIGS. 16A to 16C, the protruding portion 14b protrudes outward from a portion positioned outside the pawl lever 14a, and has a lower side portion that is gradually inclined upward toward the outside and that is inclined gradually upward toward the front side of the vehicle. In this door latch device, upon opening operation of the outside door handle or the inside door handle with a stroke larger than usual in a state where the inertial lever portion 22 is arranged at the second non-operating position, the open link 20 moves upward, and therefore, the inertial mass portion 22c of the inertial lever portion 22 abuts on the protruding portion 14b. In this state, when the open link 20 further moves upward, the inertial lever portion 22 rotates toward the outside of the vehicle relative to the lever body 21, against the spring force of the torsion spring 23 in the rotation direction, by the inclination action of the protruding portion 14b, and when the inertial lever portion 22 is arranged at the first non-operating position, an abutment state between the restriction protrusion 21j and the front end surface of the inclined protrusion 22j is released. As described above, the projection 22d is provided with the inclined surface 22k. Therefore, as illustrated in FIG. 17, according to this door latch device, upward movement of the open link 20 smoothly moves the inertial lever portion 22 to the first non-operating position along the inclined surface 22k, with no possibility of a situation in which an excessive external force is applied to the inertial lever portion 22 and the lever body 21.

When the abutment state between the restriction protrusion 21j and the front end surface of the inclined protrusion 22j is released, the inertial lever portion 22 moves toward the front side of the vehicle, against the spring force along the axis of the torsion spring 23, by the inclination action of the protruding portion 14b. Thereafter, upon movement of the projection 22d forward from the restriction protrusion 21j, the inertial lever portion 22 returns to the operating position by the spring force of the torsion spring 23 in the rotation direction. This configuration makes it possible to open the side door emergently by performing the operation described above while preventing the side door from being unexpectedly opened immediately after the impact force is applied to the vehicle. Moreover, positioning of the open link 20 with respect to the latch unit 10 makes it possible to cause the inertial lever portion 22 to reliably abut on the protruding portion 14b, and therefore, the inertial lever portion 22 arranged at the second non-operating position is allowed to be more reliably returned to the operating position.

Note that the above embodiments exemplify the door latch device mounted on the side door of the four-wheeled vehicle, but as a matter of course, the door latch device may be mounted on other types of vehicles. In this case, the door does not necessarily need to be provided on a side surface of the vehicle, or the door does not need to have a hinge shaft extending in a vertical direction as well.

Furthermore, the above embodiments exemplify the inertial lever portion 22 rotating to first non-operating position relative to the lever body 21 and then moving to the second non-operating position, but in the present disclosure, it will suffice to arrange the inertial lever portion 22 at the first non-operating position, and the inertial lever portion 22 does not always need to be moved to the second non-operating position.

Furthermore, in the above embodiments, the support shaft portion 21b is provided at the lever body 21 and the insertion portion 22b is provided in the inertial lever portion 22, but the support shaft portion 21b may be provided at the inertial lever portion 22 and the insertion portion 22b may be provided in the lever body 21.

According to the present disclosure, the pawl lever is provided with the protruding portion that returns the inertial lever portion to the operating position, and therefore, replacement of the housing is not required and replacement work with the existing door latch device is facilitated.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A door latch device comprising:
an open link configured to change to an unlocked state and a locked state and operate upon opening operation of a door handle; and
a pawl lever configured to release an engagement state of a pawl with a latch when an operation force is applied via the open link,
the open link being configured to transmit the operation force to the pawl lever when opening operation of the door handle is performed in the unlocked state,
the open link including:
a lever body configured to displace to an unlock position corresponding to the unlocked state and a lock position corresponding to the locked state and configured to move according to opening operation of the door handle;
an inertial lever portion configured to move to an operating position and a non-operating position relative to the lever body; and
a releasing bias member configured to bias the inertial lever portion so that the inertial lever portion is maintained at the operating position relative to the lever body,
the inertial lever portion being configured to transmit the operation force to the pawl lever only when opening operation of the door handle is performed while the lever body is arranged at the unlock position and the inertial lever portion is arranged at the operating position,
wherein the pawl lever is provided with a protruding portion configured to abut on the inertial lever portion to return the inertial lever portion to the operating position when opening operation of the door handle is performed with a preset return stroke while the inertial lever portion is arranged at the non-operating position.

2. The door latch device according to claim 1, wherein
the inertial lever portion is arranged so as to be rotatable about a predetermined rotation axis relative to the lever body and arranged so as to be movable along a predetermined shifting axis when the inertial lever portion is rotated to a predetermined first non-operating position, and
a shift mechanism and a restriction mechanism are provided between the lever body and the inertial lever portion,
wherein the shift mechanism is configured to shift the inertial lever portion to a predetermined second non-operating position along the shifting axis when the inertial lever portion is rotated to the first non-operating position relative to the lever body, and
wherein the restriction mechanism is configured to prevent movement of the inertial lever portion to the operating position when the inertial lever portion is arranged at the second non-operating position.

3. The door latch device according to claim 2, wherein the restriction mechanism includes a first rotation blocking portion provided at the lever body and a second rotation blocking portion provided at the inertial lever portion, the first rotation blocking portion and the second rotation blocking portion being configured to face each other in a circumferential direction around the rotation axis when the inertial lever portion is arranged at the second non-operating position.

4. The door latch device according to claim 2, wherein the restriction mechanism includes a first shift blocking portion provided at the lever body and a second shift blocking portion provided at the inertial lever portion, the first shift blocking portion and the second shift blocking portion being configured to face each other along the shifting axis when the inertial lever portion is arranged at the second non-operating position.

5. The door latch device according to claim 2, wherein the shift mechanism includes a shifting bias member configured to
have a spring force storage state when the inertial lever portion is arranged at the operating position relative to the lever body and
shift the inertial lever portion to the second non-operating position when the inertial lever portion is moved to the first non-operating position relative to the lever body.

6. The door latch device according to claim 5, wherein the releasing bias member is a torsion spring constituted around the rotation axis, and also functions as the shifting bias member.

7. The door latch device according to claim 6, wherein the protruding portion is configured to abut on the inertial lever portion when opening operation of the door handle is performed with a return stroke while the inertial lever portion is arranged at the second non-operating position, slide the inertial lever portion against a biasing force of the shifting bias member, and return the inertial lever portion to the operating position through the first non-operating position.

8. The door latch device according to claim 4, wherein the second shift blocking portion is provided with an inclined surface configured to bring the inertial lever portion into slide contact with the protruding portion during abutment of the inertial lever portion on the protruding portion, and move the inertial lever portion to the first non-operating position.

9. The door latch device according to claim 1, wherein
one of the lever body and the inertial lever portion is provided with a support shaft portion, and the other of the lever body and the inertial lever portion is provided with an insertion portion having an insertion hole, the insertion portion being externally mounted around the support shaft portion through the insertion hole so that the lever body and the inertial lever portion are arranged to be relatively rotatable, and
an engagement mechanism is provided between the support shaft portion and the insertion portion, the engagement mechanism being configured to
permit attachment and detachment of the support shaft portion to and from the insertion hole when the inertial lever portion is at a predetermined attachment/detachment position relative to the lever body, and
block attachment and detachment of the support shaft portion to and from the insertion hole when the inertial lever portion is arranged at the operating position and the non-operating position.

10. The door latch device according to claim 9, wherein
the inertial lever portion is arranged so as to be rotatable about a predetermined rotation axis relative to the lever body and arranged so as to be movable along a predetermined shifting axis when the inertial lever portion is rotated to a predetermined first non-operating position,
the open link moves along a virtual operation plane including an axis of the support shaft portion when opening operation of the door handle is performed to allow transmission of the operation force to the pawl lever,
the engagement mechanism includes a protruding engagement portion that is provided at the support shaft portion and an insertion cutout portion that is provided in the insertion portion, the protruding engagement portion being provided in a direction orthogonal to the rotation axis, the insertion cutout portion having a size large enough to allow insertion of the protruding engagement portion, and
when the inertial lever portion is arranged at the operating position relative to the lever body, the insertion cutout portion extends in a direction not perpendicular to the operation plane.

11. The door latch device according to claim 9, wherein
the inertial lever portion is arranged so as to be rotatable about a predetermined rotation axis relative to the lever body and arranged so as to be movable along a predetermined shifting axis when the inertial lever portion is rotated to a predetermined first non-operating position,
wherein a shift mechanism and a restriction mechanism are provided between the lever body and the inertial lever portion,
wherein the shift mechanism is configured to shift the inertial lever portion to a predetermined second non-operating position along the shifting axis when the inertial lever portion is rotated to the first non-operating position relative to the lever body, and
wherein the restriction mechanism is configured to prevent movement of the inertial lever portion to the operating position when the inertial lever portion is arranged at the second non-operating position,
wherein the shift mechanism includes a shifting bias member configured to
have a spring force storage state when the inertial lever portion is arranged at the operating position relative to the lever body and
shift the inertial lever portion to the second non-operating position when the inertial lever portion is moved to the first non-operating position relative to the lever body,
wherein the lever body is provided with the support shaft portion, and the inertial lever portion is provided with the insertion portion,
wherein the lever body includes
a seating surface that is provided at one end of the support shaft portion, where an end of the shifting bias member abuts on the seating surface, and
an engagement claw that is provided at a position facing the seating surface and configured so that the shifting bias member is mounted between the seating surface and the engagement claw, and
wherein the inertial lever portion is provided with a biasing force receiving surface configured to arrange the shifting bias member so as to have the spring force storage state, between the biasing force receiving surface and the seating surface, when the inertial lever portion is arranged at the operating position relative to the lever body.

12. The door latch device according to claim 11, wherein the seating surface is configured to have a contact area with the shifting bias member larger than the engagement claw.
